(19) United States
(12) Patent Application Publication
(10) Pub. No.: US 2018/0088270 A1
(43) Pub. Date: Mar. 29, 2018

(54) LIGHTGUIDE ASSEMBLY FOR ELECTRONIC DISPLAY

(71) Applicant: Amazon Technologies, Inc., Seattle, WA (US)

(72) Inventors: Tero Johannes Tuohioja, Espoo (FI); Jori Juhani Oravasaari, Helsinki (FI); Kari Juhani Rinko, Helsinki (FI)

(21) Appl. No.: 15/280,877

(22) Filed: Sep. 29, 2016

(51) Int. Cl. F21V 8/00; G02B 26/00

(52) U.S. Cl. CPC G02B 6/0045; G02B 26/005; G02B 6/0036; G02B 6/002

(57) ABSTRACT

A display device using specular reflection, such as an electrowetting display, includes a lightguide having internal optics that direct light propagating through the lightguide onto a reflective surface of the display device so that the light is reflected at an angle that improves the illumination and/or contrast ratio of an image displayed to a viewer. Various cavity shapes for the internal optics provide different manufacturing and operation efficiencies.

### BACKGROUND

Electronic displays are found in numerous types of electronic devices including, without limitation, electronic book (“eBook”) readers, mobile phones, laptop computers, desktop computers, televisions, appliances, automotive electronics, and augmented reality devices. Electronic displays may present various types of information, such as user interfaces, device operational status, digital content items, and the like, depending on the kind and purpose of the associated device.

Different display technologies may require that the pixels in the display be back-lit and/or front-lit. Light-emitting diode (LED) devices, for example, use a backlight that shines through the pixels toward the viewer to make an image formed by the pixels visible on the display. In reflective displays, such as electrowetted displays (EWDs), light incident on the display from the viewing side is reflected by internal surfaces back to the viewer to illuminate the image. Natural or ambient light and/or a frontlight may provide the incident light.

Displays typically include a lightguide containing optical structures that direct light from a light source onto, through, or away from the display. The optical features are typically fabricated on a side of a piece of material, such as a plastic or glass plate that forms part or all of the lightguide. One type of feature is a specifically-designed void, or “cavity,” formed into the lightguide material (i.e., plastic or glass) and typically filled with air. The configuration of surfaces and dimensions of the air cavity determine how light incident on the air cavity is reflected and refracted.

### BRIEF DESCRIPTION OF THE DRAWINGS

The detailed description is set forth with reference to the accompanying figures. The use of the same reference numbers in different figures indicates similar or identical items or features.

FIG. 1 is a diagram illustrating a plan view of a lightguide including an exemplary embodiment of lightguide optic structures having cavity shapes in accordance with the present disclosure.

FIG. 2 is a diagram illustrating a material stack of a display device, including an inset close-up view of a lightguide including another exemplary embodiment of optic structures having cavity shapes in accordance with the present embodiment.

FIG. 3A is a top perspective view of a first embodiment of a cavity shape in accordance with the present disclosure.

FIG. 3B is a top view of the cavity shape of FIG. 3A.

FIG. 3C is a cross-sectional side view of the cavity shape of FIG. 3A.

FIG. 3D is a bottom view of the cavity shape of FIG. 3A.

FIG. 4A is a top perspective view of a second embodiment of a cavity shape in accordance with the present disclosure.

FIG. 4B is a cross-sectional side view of the cavity shape of FIG. 4A, taken along line 4-4.

FIG. 4C is a group of plots illustrating light focus onto the reflective surface of a display device by a lightguide using the cavity shape of FIG. 4A.

FIG. 5A is a bottom perspective view of a third embodiment of a cavity shape in accordance with the present disclosure.

FIG. 5B is a side plan view of a display device including cavities formed with the cavity shape of FIG. 5A, showing the refraction of propagated light.

FIG. 6A is a top perspective view of a fourth embodiment of a cavity shape in accordance with the present disclosure.

FIG. 6B is a cross-sectional side view of the cavity shape of FIG. 6A, taken along line 6-6.

FIG. 6C is a group of plots illustrating light focus onto the reflective surface of a display device by a lightguide using the cavity shape of FIG. 6A.

FIG. 7 is a perspective view of a fifth embodiment of a cavity shape in accordance with the present disclosure.

FIG. 8 is a perspective view of a sixth embodiment of a cavity shape in accordance with the present disclosure.

FIG. 9 is a perspective view of a seventh embodiment of a cavity shape in accordance with the present disclosure.

FIG. 10 is a perspective view of an eighth embodiment of a cavity shape in accordance with the present disclosure.

FIG. 11 is a diagram illustrating a plan view of another embodiment of a lightguide in accordance with the present disclosure.

FIG. 12 is a diagram illustrating a plan view of another embodiment of a display device having two lightguides.

FIG. 13 is a diagrammatic flowchart illustrating an exemplary method of making a lightguide, in accordance with the present disclosure.

### DETAILED DESCRIPTION

In various embodiments described herein, an electronic device includes a display device (herein, “display”) for presenting content and other information in the form of images generated by emission and/or reflection of light from a matrix of pixels. The matrix can include hundreds of thousands or millions of pixels arranged in rows and columns and determining the maximum resolution of the image. In some examples, the electronic devices may include one or more components associated with one or more types of pixel-based displays, such as liquid crystal displays (LCDs), light-emitting diode (LED) displays, plasma displays, and electrowetting displays (EWDs); examples of such components include a touch sensor component layered atop the display for detecting touch inputs, a front light or back light component for lighting the display, a cover layer component having antiglare, antireflective, anti-fingerprint, and/or anti-cracking properties, and the like. In particular, the display includes a lightguide having internal structures for redirecting incident light as described below.

A display may be a transmissive, reflective, or transflective display that generally includes an array of pixels and control circuitry that produces an image by selecting particular pixels to transmit, reflect or block light. Some reflective displays, such as EWDs, are specular reflective displays in which a ray of light enters the display from the viewing side and passes through some of the pixels, hits a reflective surface underneath the pixels at a particular angle of incidence, and reflects off of the reflective surface at a reflection angle based on the angle of incidence. In any display, the light passing through the pixels needs to be transmitted and/or reflected back to the viewer, whose line-of-sight is parallel or nearly parallel to the normal of the display surface; to maximize the contrast ratio, the display needs as much of this light as possible to be parallel or nearly parallel (i.e., within about ten degrees) to the normal of the display.

For reflective displays in any light setting (e.g., natural outdoor light, ambient lighting from a lamp, or device-based lighting from a backlight or frontlight), a less-than-optimal amount of light incident on the viewing side of the display may be entering at the desired angle (or range of angles, i.e., within ten degrees of the normal in any direction). Similarly for transmissive displays that are backlit by discrete light sources, light would enter the pixels at an angle proportional to the distance of the pixel from the light source. The display therefore includes a lightguide, which is a light-transmissive, internally reflective layer of material. In reflective displays the lightguide may be on the “viewing side” of the reflective surface (i.e., between the reflective surface and the viewer), and in transmissive displays the lightguide may be on the “back side” of the pixels (i.e., between the pixel array and the back of the device). The lightguide may include internal structures that direct the incident light through the lightguide and onto a desired location on the reflective surface at the desired angle. One such internal structure is a cavity, which is a void within the lightguide material that has a desired configuration and volume and is filled with air or another suitable fluid for creating a refractive index gap between the lightguide material and the cavity. If the cavity is properly designed, light entering the lightguide from the viewing side and impacting the cavity will be refracted toward the reflective surface at the desired angle.

The goals of cavity design are to maximize “display light,” which is incident light delivered to the reflective surface within about ten degrees of the normal, and to minimize both “stray light,” which is light refracted back out of the viewing side of the lightguide, and “flood light,” which is light delivered to the reflective surface outside of the display light angular range and can reduce contrast ratio while contributing little or no useful illumination of the image. Cavities may be very small to allow dense packing of the structures in the lightguide material, but designing them too small creates manufacturing inefficiencies. The minimum size of the cavities may be controlled by the cavity configuration, or “profile,” and the manufacturing techniques, among other factors. This disclosure presents several air cavity designs, each of which is an improvement over existing solutions, and some of which have certain advantages as compared to others.

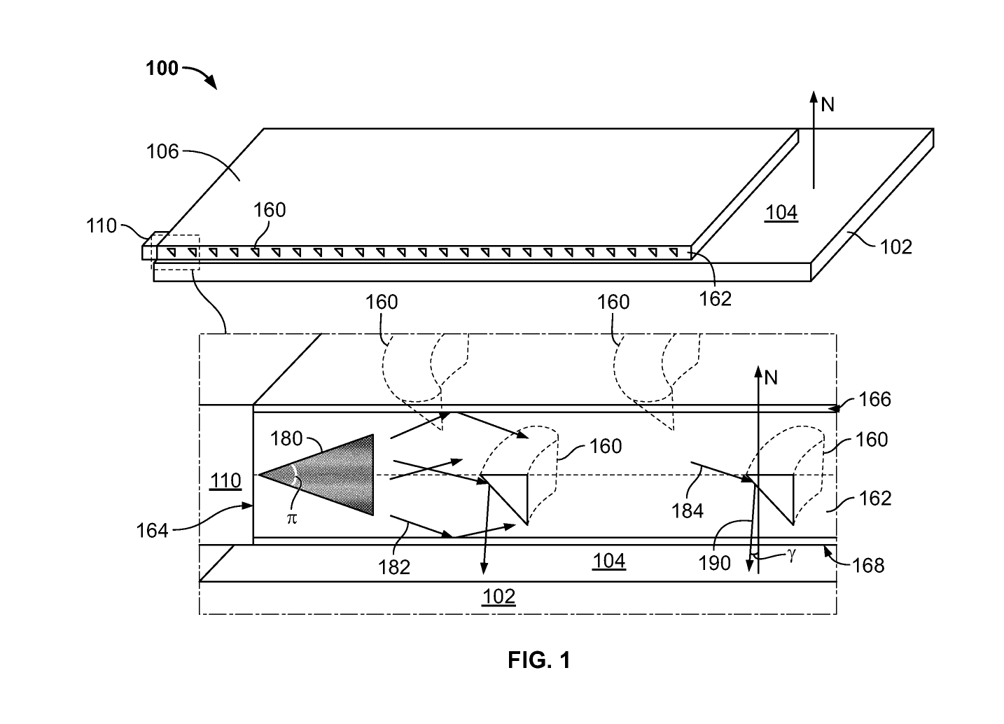

Referring to FIG. 1, a display device 100 for an electronic display may include a display panel 102 The display panel 102 may include one or more display components, such as a support plate for providing a rigid mounting surface, and a pixel array with control circuitry for producing an image, as described above. Additionally, the display panel 102 may include a reflective surface 104. The reflective surface 104 may be on the viewing side (i.e., the side of the display device 100 that faces the viewer when the electronic device is in use) of the display device 100. In some embodiments, the reflective surface 104 may be an exterior surface of the display panel 102. In other embodiments, such as when the display device 100 is an EWD, the reflective surface 104 may be “under” the pixel array (i.e., the pixel array may be toward the viewing side of the display device 100 relative to the reflective surface 104, and/or the reflective surface 104 may be between the pixel array and a support plate of the display panel 102). In this arrangement, light entering the display device 100 from the viewing side and passing through the pixel array impinges on the reflective surface 104 and is reflected.

In some embodiments, the reflective surface 104 may exhibit specular reflection of incident light. Further, the reflective surface 104 may be planar, having a normal N directed toward the viewing side of the display device 100. This reflective surface 104 reflects incoming light incident on the reflective surface 104 at a particular angle, measured with respect to the normal N, away from the reflective surface 104 as outgoing light traveling at the same angle with respect to the normal N as the incoming light was traveling. As described above, when the angle of incidence is within a display range, such as at 10 degrees or less with respect to the normal N, the outgoing light becomes display light, traveling back through the pixels and out of the viewing side of the display device 100, illuminating the image formed by the pixels at a suitable contrast ratio.

The display device 100 further includes a lightguide 106 disposed “over” (i.e., on the viewing side of the display panel 102, such that the pixel array is between the reflective surface 104 and the lightguide 106) the display panel 102. The lightguide 106 may comprise a lightguide material, or a combination of lightguide materials, that make the lightguide light-transmissive and may further make parts of the lightguide reflective. The lightguide 106 may include a body 162 that is made of a light-transmissive material having a first refractive index that facilitates propagation of light in any direction through the body 162. The body 162 may include or be disposed between outer surfaces 166, 168 on the exterior of the body 162 and are parallel to the reflective surface 104. In some embodiments, the outer surfaces 166, 168 may include patterns, structures, etchings, coatings, adhesives, or other components that reflect light.

In particular, due to these components the outer surfaces 166, 168 may exhibit total internal reflection (TIR) of light that enters and propagates through the body 162 from a side 164 of the lightguide 106. In some embodiments, the outer surfaces 166, 168 may conform to a profile of reflection, in which light within the body 162 that is traveling at an angle of 18 degrees or less with respect to the planes of the outer surfaces 166, 168 (i.e., within a cone 180 with an apex angle of 18 degrees and an aperture of 36 degrees) is spectrally reflected off of each outer surface 166, 168 and thus propagates through the lightguide 106 as propagated light 182. The display device 100 may further include a light source 110, such as an LED frontlight, coupled to or otherwise emitting the light into the body 162 through the side 164 of the lightguide 106. In some embodiments, the light source 110 may include lenses and/or other structures or components that control the light source 110 to emit the light in the shape of the cone 180.

The lightguide 106 further includes a plurality of cavities 160 formed into the body 162 between the outer surfaces 166, 168. The cavities 160 may be voids, and may be filled with air and/or with another substance that has a different refraction index from the material of the body 162. The material filling the cavities 160 may be selected to maximize a gap, or difference, between the refractive indices, which provides the optimal amount of control over the direction in which light incident on a cavity 160 is redirected. A particular cavity receives a portion 184 of the propagated light 182 on one or more of the cavity's 160 faces, as described below. In accordance with the present disclosure, the cavity 160 directs the portion 184 of light toward the reflective surface 104 as display light 190 traveling at an angle within the display range of angles for the display device 100 (e.g., 10 degrees or less with respect to the normal N of the reflective surface 104). The display light 190 thus reflects off of the reflective surface 104 at the same angle, passes through the pixels and lightguide 106, and projects out of the viewing side of the display device 100 to the viewer. The cavities 160 may be used to redirect (collimating light, distribution of light, etc.) light from a light source 110 in some implementations to provide front lighting or backlighting for an electronic device. The cavities 160 may also be used to focus light when implemented as a lens, project collimated light as a collimated film, act as a light polarizer, and/or provide light incoupling, among other possible uses.

The cavities 160 may be voids formed into a portion of the body 162 and then filled during manufacture, using any suitable process(es) such as those described in U.S. patent application Ser. No. 13/080,581, entitled “Internal Cavity Optics,” filed on Apr. 5, 2011, and incorporated fully herein by reference. For example, the cavities may be formed using optical cavity patterns in a manufacturing process such as roll-to-roll manufacturing that creates small cavities (e.g., micro-cavities, nano-cavities, etc.) across a surface of a thin material (e.g., a transparent foil, etc.). The thin material, once processed to create the cavities, may be laminated to a second material to join the surface having the cavities with the second material and thereby enclose the cavities within the resulting combination. The lamination process may fuse the materials together to effectively remove the joined surface such that the combined material appears to be formed of a single sheet of material. The cavities may be filled with air or another medium (e.g., a fluid, gel, gas, solid, etc.), which enable the cavity to redirect light in accordance with design requirements. By manufacturing the internal cavity optics in this manner, the cavities may be protected against contact by other parts, and thus remain free of dirt, debris, or other contamination that may reduce functionality or an effectiveness of the optics. In some instances, additional layers of material may be laminated together to create additional layers of cavities 160 that may be aligned with or offset from other cavities 160 with respect to any axis (i.e., XYZ axes). Additionally or alternatively, the additional layers may include other internal optical structures. For example, one layer may include cavities that create a light polarizer while another layer may include other light management gratings, such as blazed gratings. Additionally or alternatively, a lightguide for the display device 100 may be manufactured using any of the methods described herein.

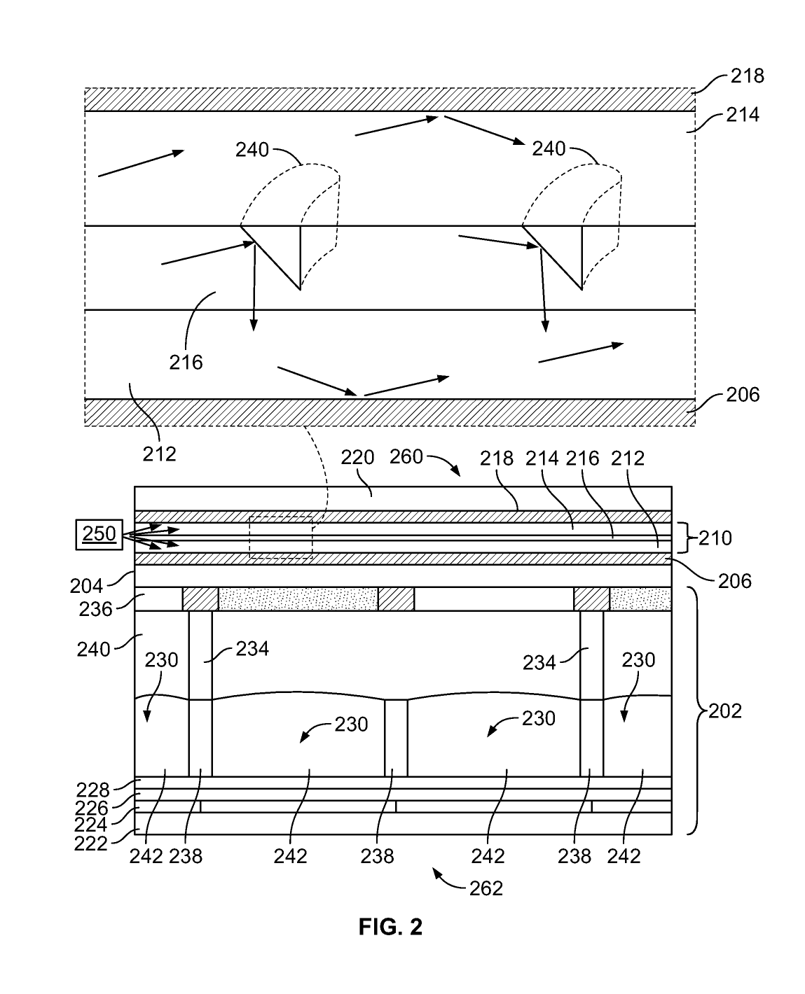

FIG. 2 illustrates an exemplary materials stack within a display device such as the display device 100 of FIG. 1. A display panel 202, such as the display panel 102 of FIG. 1, may be the first or base layer. The display panel 202 (of exemplary thickness 1.02 mm) may include a support panel 222, an electrode layer 224, a barrier layer 226, a reflective layer 228 having or forming a reflective surface of the display panel 202, an array of pixels 230, and a support plate 236, as well as control circuitry, optically transparent protective layers, and any other layers known for generating an image in EWDs or similar reflective displays. The support panel 222 may be a PCB, glass panel, or other suitable panel construction for providing a base or foundation for the layers built on “top” of the support panel 222.

In various embodiments, electrode layer 224 consists of individual pixel electrodes each addressing an individual pixel. The individual pixel electrodes may be connected to a transistor, such as a thin film transistor (TFT) (not shown), that is switched or otherwise controlled to either select or deselect an electrowetting pixel 230 using an active matrix addressing scheme, for example. A TFT is a particular type of field-effect transistor that includes thin films of an active semiconductor layer as well as a dielectric layer and metallic contacts over a supporting (but non-conducting) substrate, which may be glass or any of a number of other suitable transparent or non-transparent materials, for example. The TFTs and corresponding data lines may be formed within electrode layer 224 or within other layers over or within support plate 222.

In some embodiments, a dielectric barrier layer 226 may at least partially separate electrode layer 224 from a reflective layer 228, also formed on bottom support plate 222. Barrier layer 226 may be formed from various materials including organic/inorganic multilayer stacks or layers. In some embodiments, reflective layer 228 may also be a hydrophobic layer, such as an amorphous fluoropolymer layer including any suitable fluoropolymer(s), such as AF1600®, produced by DuPont, based in Wilmington, Del. Reflective layer 228 may also include suitable materials that affect wettability of an adjacent material, for example.

Pixel walls 238 form a patterned electrowetting pixel grid on reflective layer 228. Pixel walls 238 may comprise a photoresist material such as, for example, epoxy-based negative photoresist SU-8. The patterned electrowetting pixel grid comprises rows and columns that form an array of electrowetting pixels 230. For example, an electrowetting pixel 230 may have a width and a length in a range of about 50 to 500 micrometers.

Oil 242 (or another opaque fluid), which may have a thickness (e.g., a height) in a range of about 1 to 10 micrometers, for example, overlays the hydrophobic reflective layer 228. Oil 242 is partitioned by pixel walls 238 of the patterned electrowetting pixel grid. A second fluid 244, such as an electrolyte solution, overlays oil 242 and pixel walls 238 of the patterned electrowetting pixel grid. Oil 242 is immiscible with second fluid 244. A support plate 236 covers second fluid 244 to maintain second fluid 244 over the array of electrowetting pixels 230. Spacers 234 may rest upon a top surface of one or more pixel walls 108 and may extend toward support plate 236. Multiple spacers 234 may be interspersed throughout the array of pixels 230. The dimensions and shape of the spacers 234 is not restricted to pillar shape as shown in FIG. 2; alternative shapes include crosses, lines of spacers, or full grid spacer structures.

A driving voltage applied across, among other things, second fluid 244 and a pixel electrode in electrode layer 224 addressing a particular electrowetting pixel 230 may control transmittance or reflectance of individual electrowetting pixels 230.

A display device as shown in FIG. 2 has a viewing side 260 on which an image formed by the display device may be viewed, and an opposing rear side 262. Support plate 236 faces viewing side 260 and support panel 222 faces rear side 262. The reflective display device may be a segmented display type in which the image is built of segments. The segments may be switched simultaneously or separately. Each segment includes one electrowetting pixel 230 or a number of electrowetting pixels 230 that may be adjacent or distant from one another. Electrowetting pixels 230 included in one segment are switched simultaneously, for example. The display device may also be an active matrix driven display type or a passive matrix driven display, for example.

As mentioned above, second fluid 244 is immiscible with oil 242. Second fluid 244 is electrically conductive and/or polar, and may be water or a salt solution such as a solution of potassium chloride in water, for example. In certain embodiments, second fluid 244 is transparent, but may be colored or light-absorbing. Oil 242 is electrically non-conductive and may for instance be an alkane like hexadecane or (silicone) oil.

The reflective layer 228 may be hydrophobic, or may contain or be contained in a hydrophobic layer. Additionally or alternatively, the reflective layer 228 and/or a reflective surface thereof may be above or below a hydrophobic layer. The hydrophobic layer is arranged on bottom support plate 222 to create an electrowetting surface area. The hydrophobic character causes oil 242 to adhere preferentially to the hydrophobic layer because oil 242 has a higher wettability with respect to the surface of the hydrophobic layer than second fluid 244 in the absence of a voltage. Wettability relates to the relative affinity of a fluid for the surface of a solid. Wettability increases with increasing affinity, and it may be measured by the contact angle formed between the fluid and the solid and measured internal to the fluid of interest. For example, such a contact angle may increase from relative non-wettability of more than 90° to complete wettability at 0°, in which case the fluid tends to form a film on the surface of the solid.

In some embodiments, oil 242 absorbs light within at least a portion of the optical spectrum and so may form a color filter. The fluid may be colored by addition of pigment particles or dye, for example. Alternatively, oil 242 may be black (e.g., absorbing substantially all light within the optical spectrum) or reflecting. The reflective layer 228, or a reflective surface thereof, may reflect light within the entire visible spectrum, making the layer appear bright, or reflect a portion of light within the visible spectrum, making the layer have a color.

If a voltage is applied across an electrowetting pixel 230, electrowetting pixel 230 will enter into an active or at least partially open state. Electrostatic forces will move second fluid 244 toward electrode layer 224 within the active pixel, thereby displacing oil 242 from that area within or above reflective layer 228 to pixel walls 238 surrounding that area, to a droplet-like form. Such displacing action at least partly uncovers oil 242 from the surface of the reflective layer 228 of electrowetting pixel 230. Due to the configuration of electrode layer 224, when the voltage is applied across the electrowetting pixel 230, oil 242 generally always move in the same direction within the pixel 230 so as to form into a droplet against the same wall 238 of the pixel 230.

A diffuser 204 (of exemplary thickness 0.75 mm) may be disposed over, and in some embodiments may be in contact with, the display panel 202. The diffuser 204 may include one or more optically clear adhesives (OCAs) (not shown) for bonding between layers (e.g., to the display panel 202) without interrupting the desired paths of light. In some embodiments, a thin (e.g., 0.20 mm) adhesive layer 206 of UV curable liquid optically-clear adhesive may be disposed over the diffuser 204 for bonding the lightguide 210. The diffuser 204 and the OCAs may cooperate to diffuse incident light traversing the diffuser 204 from either or both of the viewing side 260 (i.e., frontlight) and the rear side 262 (i.e., backlight).

The lightguide 210, which may include the cavities described herein, may be disposed over the diffuser 204. The lightguide may comprise one or more substrates (e.g., a transparent thermoplastic such as PMMA or other acrylic), a layer of lacquer and multiple grating elements formed in the layer of lacquer that function to propagate light from a light source towards the reflective surface. In some embodiments, the cavities are formed as internal structures by first providing a lower portion 212 (of exemplary thickness 0.20 mm, which may be a lightguide film) of the lightguide 210, forming the cavities into the upper surface of the lower portion 212, depositing an adhesive layer 216, such as a lacquer (of exemplary thickness 0.025 mm) over the lower portion 212, placing a top portion 214 (of exemplary thickness 0.375 mm, which may be a lightguide film or a lightguide plate) over the lower portion 212 and the adhesive layer 216, and curing the adhesive layer 216 to form the lightguide 210 (of exemplary thickness 0.6 mm).

Another adhesive layer 218, which may be a gel or other suitable OCA (of exemplary thickness 0.175 mm) may be deposited over the lightguide 210, and a touch sensor 220, which may be any suitable touch sensor for use with reflective displays (having an exemplary thickness of 0.121 mm) may then be disposed over and adhered to the lightguide 210. As several examples of suitable touch sensors, touch sensor 220 may comprise a capacitive touch sensor, a force sensitive resistance (FSR), an interpolating force sensitive resistance (IFSR) sensor, or any other type of touch sensor. In some instances, the touch sensor 220 is capable of detecting touches as well as determining an amount of pressure or force of these touches. The touch sensor 220 may be electrically connected to signal processing components of the display device using suitable conductors 222, such as anisotropic conductive film, disposed above and/or below the touch sensor 220. A final OCA layer 224 may then be deposited on the touch sensor 220, and a clear glass top panel 226, or “screen,” may thus be adhered to the touch sensor 220 at the top of the stack. The top panel 226 may include a transparent substrate or sheet having an outer layer that functions to reduce at least one of glare or reflection of incident ambient light. In some instances, the top panel 226 may comprise a hard-coated polyester and/or polycarbonate film, including a base polyester or a polycarbonate, that results in a chemically bonded UV-cured hard surface coating that is scratch resistant. One or more metal layers 228 may be included in the top panel 226 to complete the circuit for the touch sensor 220.

A frontlight 250, such as the light source 110 or another LED, may be attached to the stack in order to emit light into the lightguide 210. Yet another OCA layer 208 may adhere the frontlight 250 to the proper position in the stack. Other configurations of layers, as well as other placement and components of the frontlight 250, may be used and are contemplated by the present exemplary description.

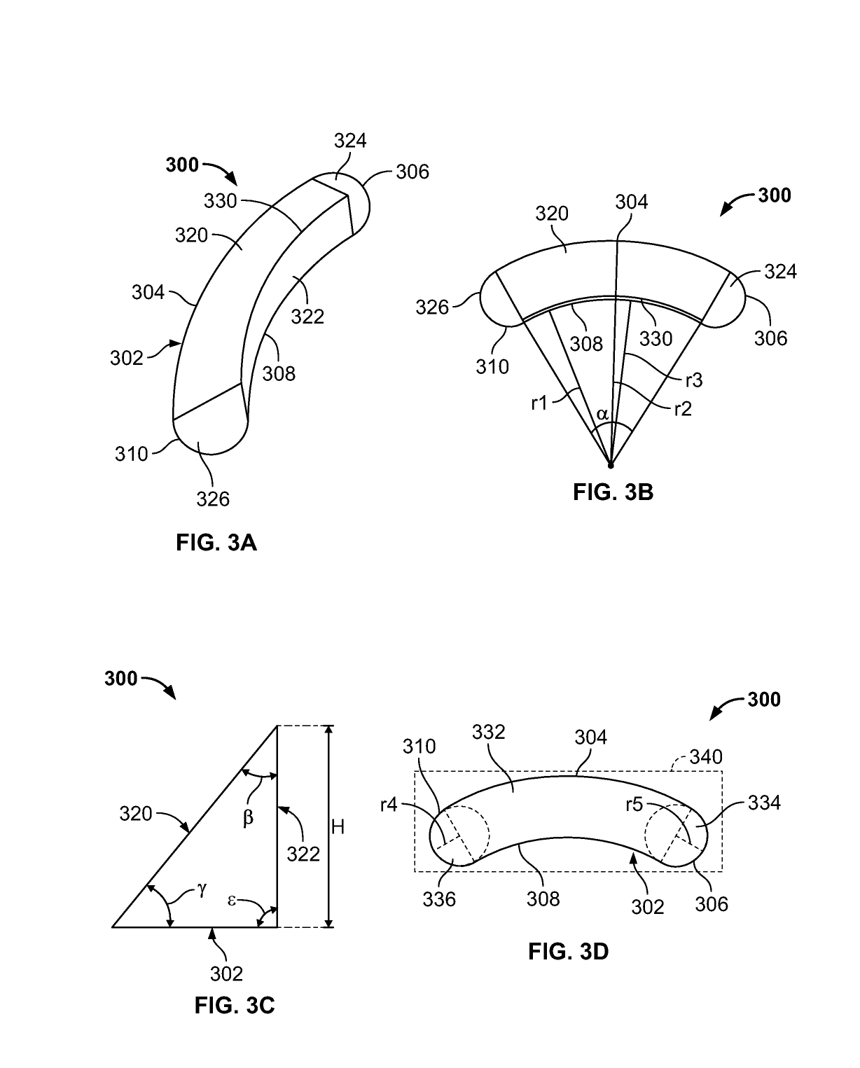

FIGS. 3A-D illustrate an exemplary cavity shape 300 which may be used to create the cavities 160 of FIG. 1. That is, in some embodiments the illustrated shape 300 may be embodied in a plurality of structures on a roll-to-roll lightguide film processing machine, pressing or otherwise imprinting the cavities into the lightguide film as described above. The cavity shape 300 may include a first end defined by a base 302 and a second end defined by a ridge 330 and spaced a distance from the first end; the distance defines a cavity height H.

The base 302 may be a planar base having a perimeter enclosing an area that, in the cavity, abuts the bottom surface of the upper portion of the lightguide body. The base 302 may be described by the shapes that define the base's 302 perimeter: a middle portion 332 of the base 302 may correspond to a sector of an annulus; a first end portion 334 of the base 302 may correspond to a partial circle, such as a semicircle with a diameter that is also the width of the annulus and aligns with a first end of the sector; and, a second end portion 336 of the base 302 may also correspond to a partial circle, such as a semicircle with a diameter that is also the width of the annulus and aligns with a second end of the sector. The perimeter of the base 302 correspondingly comprises the outer edges of the portions 332, 334, 336 of the base 302: a first edge 304 is the outer edge of the sector, and thus lies on the outer circumference of the annulus and is arcuate with a radius equal to the outer radius of the annulus; a second edge adjoining and extending from the first edge is arcuate with a radius of one-half the width of the base 302/middle portion 334; a third edge adjoining and extending from the second edge is the inner edge of the sector, and thus lies on the inner circumference of the annulus and is arcuate with a radius equal to the inner radius r2 of the annulus; and, a fourth edge adjoining and extending from the third edge and meeting the first edge is arcuate with a radius of one-half the width of the base 302/middle portion 334.

FIG. 3D best illustrates the exemplary base 302, from below the shape 300. Other shapes for the portions 332, 334, 336 besides those illustrated may be used. For example, the arcuate edges 304, 308 of the middle portion 332 may lie on non-concentric circles, so that the edges 304, 308 are not parallel, or one or both of the edges 304, 308 may lie on an ellipse rather than a circle. In another example, the sector angle α, which in the illustrated shape 300 determines the arc length for both edges 304, 308 of the middle portion 332 and is about 60 degrees, may determine the arc length of only the first edge 304, while a different angle determines the arc length of the section edge 308. In other examples, one or both of the end portions 334, 336 may be a partial circle, in some embodiments a semicircle (i.e., the radii r4, r5 of the circles defining the end portions 334, 336 are equal to half the width of the annulus), or may be part or all of an ellipse, a triangle, a rectangle, or another suitable shape that contributes to the desired optical characteristics of the cavities formed by the cavity shape 300.

Giving volume to the shape 300, a plurality of contiguous surfaces may extend from the perimeter of the base and may taper from the base at the first end to an essentially linear ridge 330 that forms a second end of the shape 300. A first surface 320 extends from the first edge 304 of the middle portion 332, and may be curved—specifically, convex—due to its base being an arc. The first surface faces into the direction of incoming propagated light; most of the portion of propagated light impinging the cavity may be incident on the face of the cavity formed by the first surface 320. Thus, the “face angle” γ between the first surface 320 and the base 302, which is also known as the “blaze angle” for blazed gratings and other blazed configurations such as the shape 300, may be critical. While ranges for face angle γ values are discussed further below, in some embodiments of the cavity shape 300 the optimal face angle γ is within about three degrees of 51 degrees. The face angle γ may be uniform along the first surface 320 or may vary, creating a wavy first surface 320. The first surface 320 may terminate at the second end of the shape 300 in an arc that may lie within a plane that is parallel to the base 302, and that may have an arc length determined by the sector angle α. The spacing of the second end from the first end is the cavity height H.

Similarly, a second surface 322 may extend from the third edge 308 of the middle portion 332 and may thus also be curved. The second surface 322 may extend at a second angle ∈ with respect to the base 302 and may intersect the first surface 320 at the second end (i.e., may terminate with the same arc that forms the termination of the first surface 320), forming the ridge 330 and forming a “ridge angle” β with the first surface 320. In embodiments where the second angle ∈ between the base 302 and the second surface 322 is 90 degrees, the ridge 330 is the same arc as the third edge 308, offset therefrom by the cavity height H. In other embodiments, the second surface 322 may be acute with the base 302, and the ridge 330 may therefore have an arc length still determined by the sector angle α, but also by an intermediate radius r3 having a value between those of the inner and outer radii of the annulus. See FIGS. 3B-C.

A third surface 324, contiguous with the first and second surfaces, may extend from the second edge 306 to the ridge, forming an “end cap” on the main portion of the shape 300. The third surface, having a partial circle at its base, may be a conical surface having an apex at the ridge; it will be understood that “conical” does not require the surface to be the exterior of a complete cone, but may simply be the portion of the cone that conforms to the second edge 306 and joins the first surface 320 to the second surface 322. In some embodiments, the end of the ridge 330 forming the apex of the third surface 324 may not be disposed over the center of the cone base, and the third surface 324 may therefore be an oblique conical surface. In the same manner, a fourth surface 326 may extend from the fourth edge 310 to the ridge, may be contiguous with the first and second surfaces, and may be conical or oblique conical with an apex at the opposing end of the ridge 330; thus, the fourth surface 326 also forms an end cap on the main portion of the shape 300.

Also illustrated in FIG. 3D is an exemplary cell boundary 340. A cell is the rectangular area of a sheet of cavity shapes 300 that is occupied by one instance of the cavity shape 300. In some embodiments, dimensions of the cavity shape 300 may be selected to minimize the cell size and maximize the number of cells that can fit on a sheet. In some embodiments, including the shape 300, the base 302 has a width and a length that govern the minimum cell width and cell length. If the cell is not large enough, the process of forming the cavity shapes 300 may be unable to generate distinct structures, as cavities having the shape 300 are so close together that they merge. An exemplary set of cavity shape 300 dimensions that requires a minimal cell boundary 340 of approximately 24 micrometers in width (measured from end cap to end cap) and 17 micrometers in length is as follows: cavity height H of 4-5 micrometers; sector angle α of 60 degrees; annular inner radius of 10 micrometers; face angle γ of between 48 and 54 degrees, inclusive, and preferably about 52 degrees; ridge angle β of about 41 degrees; and semicircular end portions 334, 336.

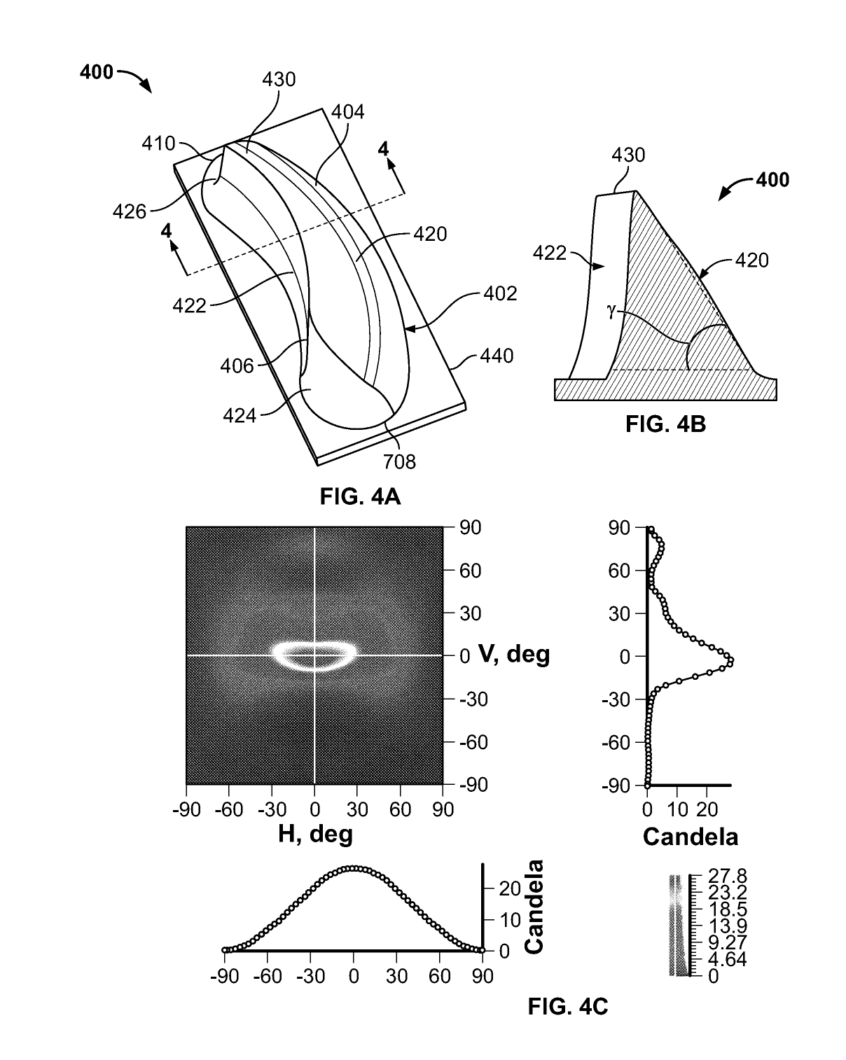

In some embodiments, the cavity shape 300 may be an ideal blazed configuration that, due to manufacturing limitations at the prescribed dimensions, may be difficult to achieve. FIGS. 4A and 4B illustrate an exemplary post-fabrication cavity shape 400 having the features of the cavity shape 300 of FIGS. 3A-D: a base 402 that is configured as the base 302 of FIGS. 3A-D, defines a minimum cell boundary 440, and has multiple edges 404, 406, 408, 410; and, a plurality of contiguous surfaces 420, 422, 424, 426 extending from the base 402 and tapering to a ridge 430. The surfaces may not be entirely smooth; as illustrated, the front surface 420 may be slightly convex and the rear surface 422 may be slightly concave, while the ridge 430 may be slightly rounded rather than a sharply defined arc. These and other imperfections, as compared to the ideal configuration of the shape 300, may impact the efficiency of a resulting cavity in refracting incident propagated light into display light. Exemplary light intensity plots obtained from testing the cavity shape 400 are shown in FIG. 4C.

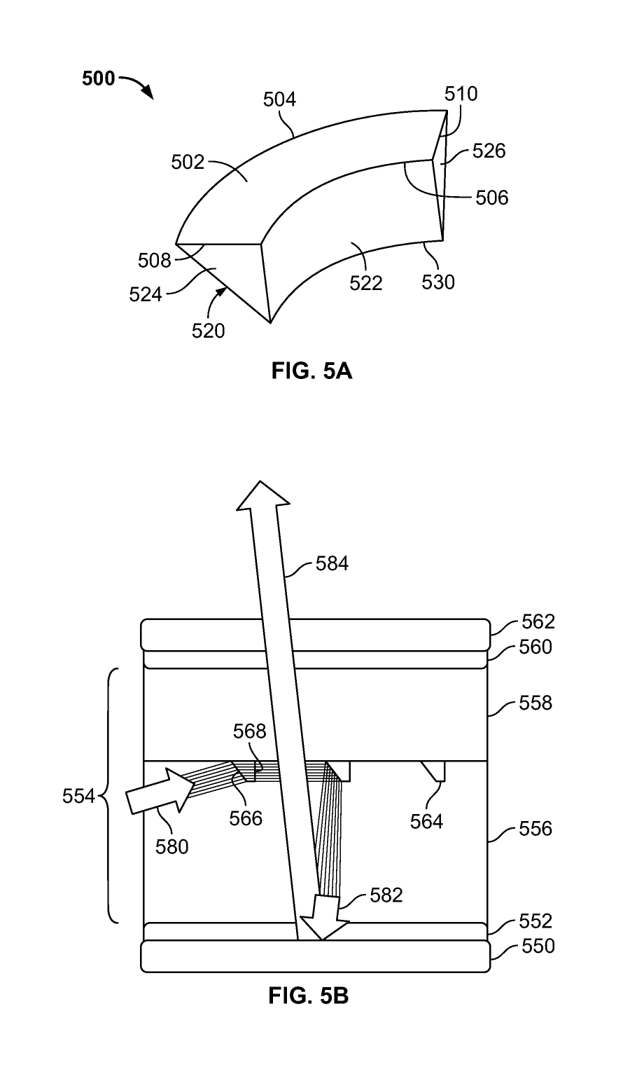

FIG. 5A illustrates an alternative ideal blazed cavity shape 500. In some embodiments, the cavity shape 500 may be similar or identical to the configuration formed by the cavity shape 300 with the end caps subtracted. Thus, a base 502 includes edges 504, 506 on the circumferences of a sector of an annulus, as well as linear edges 508, 510 each joining the arcuate edges 504, 506 at opposing ends of the sector. The sector angle may be 60 degrees as described above, or another angle such as 90 degrees as illustrated. A curved front surface 520 extends from the first edge 504, and a curved rear surface 522 extends from the second edge 506; the surfaces 520, 522 intersect to form an arcuate ridge 530. A triangular surface 524, 526 at either end of the configuration is formed by the cooperation of the base 502, the front surface 520, and the rear surface 522.

FIG. 5B illustrates the operation of cavities 564 formed into a lower portion 556 of a lightguide 554 using the cavity shape 500. An upper portion 558 of the lightguide 554 may be disposed over the lower portion 556 to seal the cavities internally. As illustrated, propagated light 580 is incident on the front face 566 of the cavity and is refracted to a substantially horizontal path, exiting through the rear face 568 of the cavity, which is perpendicular to the path of the refracted light. The refracted light may then impinge the front face 566 of the next cavity and be refracted from substantially horizontal into the range of angles required for the light to be display light (e.g., within 10 degrees of the reflective surface 550 normal). The now down-coupled light 582 passes through an OCA layer 552 and impacts the reflective surface 550, the being reflected back through the lightguide 554, upper OCA layer 560, and the screen 562 as display light 584 that enhances the illumination and contrast ratio of the image for the viewer.

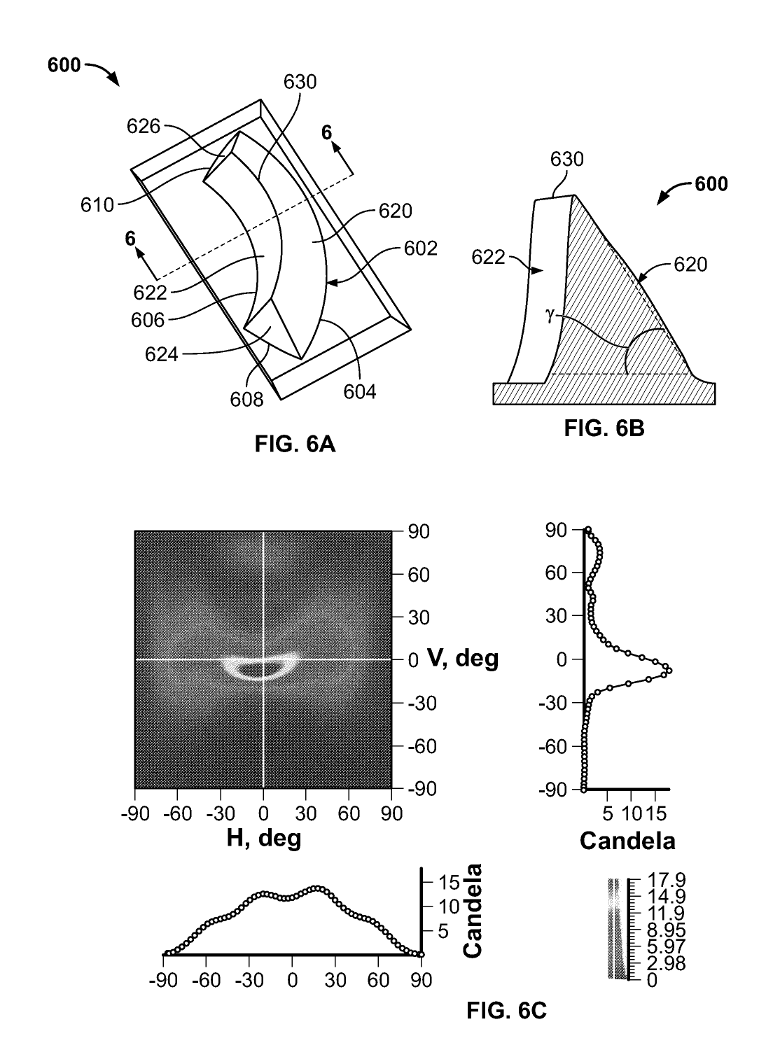

In some embodiments, the cavity shape 500 may be an ideal blazed configuration that, due to manufacturing limitations at the prescribed dimensions, may be difficult to achieve. FIGS. 6A and 6B illustrate an exemplary post-fabrication cavity shape 600 having the features of the cavity shape 500 of FIG. 5A: a base 602 that is shaped as the base 502 of FIG. 5A and has multiple edges 604, 606, 608, 610; and, a plurality of contiguous surfaces 620, 622, 624, 626 extending from the base 602 and tapering to a ridge 630. The surfaces may not be entirely smooth; as illustrated, the front surface 620 may be slightly convex and the rear surface 622 may be slightly concave, while the ridge 630 may be slightly rounded rather than a sharply defined arc. These and other imperfections, as compared to the ideal shape 500, may impact the efficiency of a resulting cavity in refracting incident propagated light into display light. Exemplary light intensity plots obtained from testing the cavity shape 600 are shown in FIG. 6C.

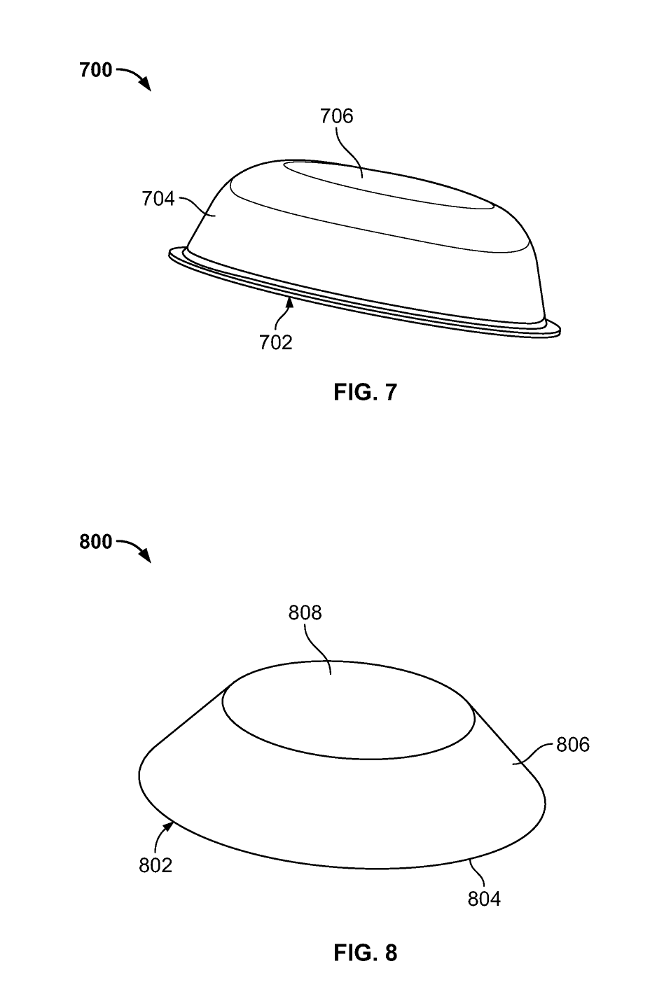

FIG. 7 illustrates an alternative cavity shape 700 having a bowl configuration. In some embodiments, the cavity shape 700 may include a base 702 that may be circular, substantially circular, elliptical, or another round shape. A curved surface 704 may extend from a perimeter of the base 702, tapering to a substantially flat second end 706. The shape 700 profile may include angles from about 40 degrees to about 50 degrees.

FIG. 8 illustrates another alternative cavity shape 800 having a frustum configuration. In some embodiments, the cavity shape 800 may include a base 802 that may be circular, substantially circular, elliptical, or another round shape. A facing surface 806 may extend from a perimeter 804 of the base 802, tapering to a substantially flat second end 808. The facing surface 806 may be at an angle with the base 802 of about 48 degrees.

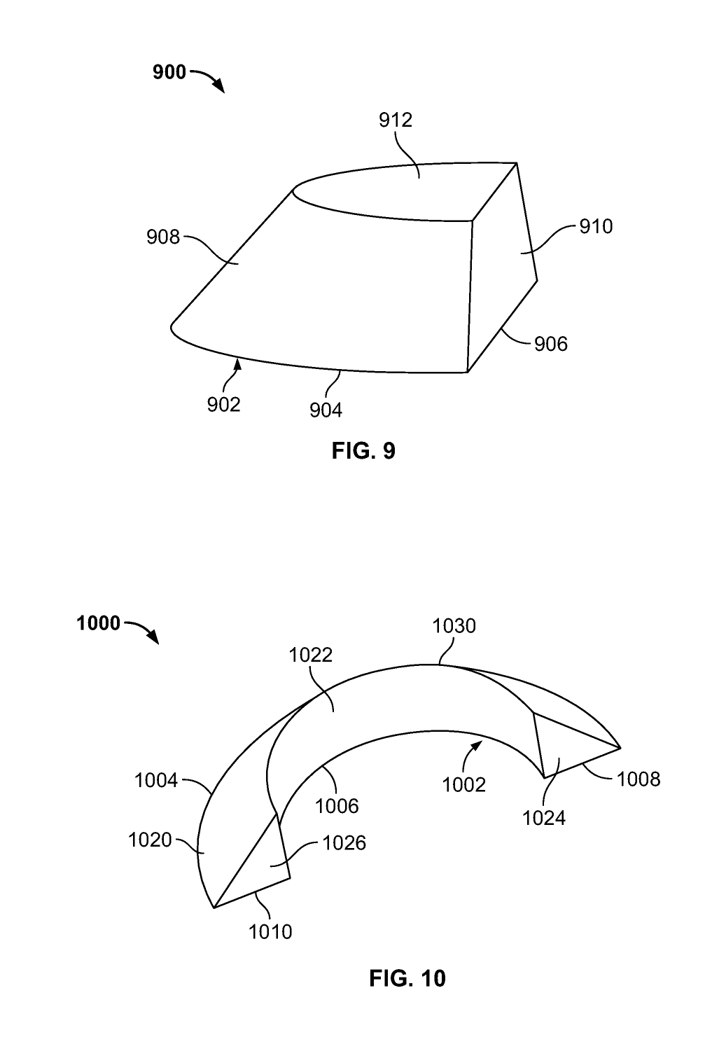

FIG. 9 illustrates another alternative cavity shape 900 which may be a halved version of the frustum configuration of the cavity shape 800 of FIG. 8. In some embodiments, the cavity shape 900 may include a base 902 that may be semi-circular or semi-elliptical; in other embodiments, the base 902 may be a sector of a circle or an ellipse. A perimeter of the base 902 may be defined by a first edge 904, which is the arcuate edge of the semicircle, and a second edge 906 corresponding to the diameter of the semicircle, connecting the ends of the first edge 904. A facing surface 908 may extend from the first edge 904, tapering to a substantially flat second end 912. The facing surface 806 may be at an angle with the base 802 of about 48 degrees. A back wall 910 may extend from the second edge 906 and terminate at the second end 912. The back wall 910 may be vertical or substantially vertical.

FIG. 10 illustrates an alternative ideal blazed cavity shape 1000. In some embodiments, the cavity shape 1000 may be similar to the cavity shape 500 with the end caps subtracted, but using a larger sector angle (i.e., 180 degrees instead of 60-90 degrees). Thus, a base 1002 includes edges 1004, 1006 on the circumferences of a sector of an annulus, as well as linear edges 1008, 1010 each joining the arcuate edges 1004, 1006 at opposing ends of the sector. A curved front surface 1020 extends from the first edge 1004, and a curved rear surface 1022 extends from the second edge 1006; the surfaces 1020, 1022 intersect to form an arcuate ridge 1030. A triangular surface 1024, 1026 at either end of the shape 1000 is formed by the cooperation of the base 1002, the front surface 1020, and the rear surface 1022.

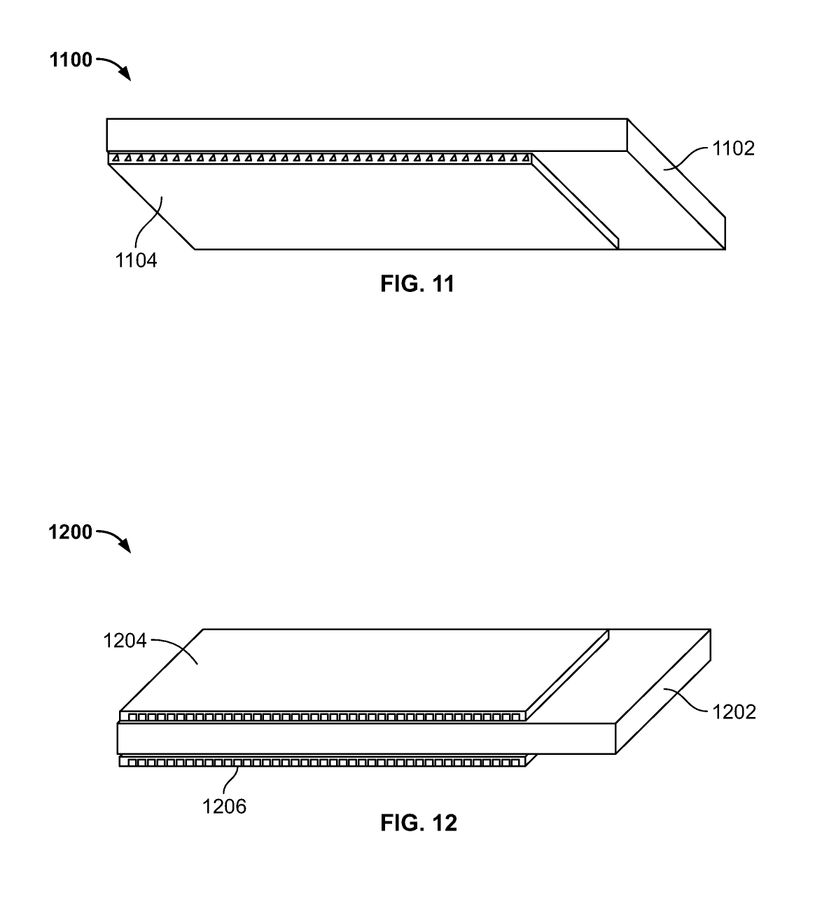

As described above, the present internal cavity optics may be used in lightguides for displays other than for specular reflective displays. Referring to FIG. 11, a display device 1100 may include a pixel array 1102 disposed on the viewing side of the device from a lightguide 1104. Thus, the lightguide 1104 is configured to direct light entering a side of the lightguide through the pixels of the pixel array, illuminating the image on the screen of the display device 1100. The lightguide 1104 may employ any of the cavity designs described herein, which in some embodiments may be flipped vertically from the above-described implementations in order to couple the propagated light from a light source (not shown) to the pixel array 1102. Similarly, as shown in FIG. 12, a display device 1200 may have light guides 1204, 1206 on both the viewing side and the back side of a display panel 1202 containing the pixel array and possibly also containing a reflective surface. The lightguide 1204 on the viewing side of the pixel array may direct light onto a reflective surface as described above, while the lightguide 1206 on the back side of the pixel array may direct light through the pixels directly or via a diffuser (not shown).

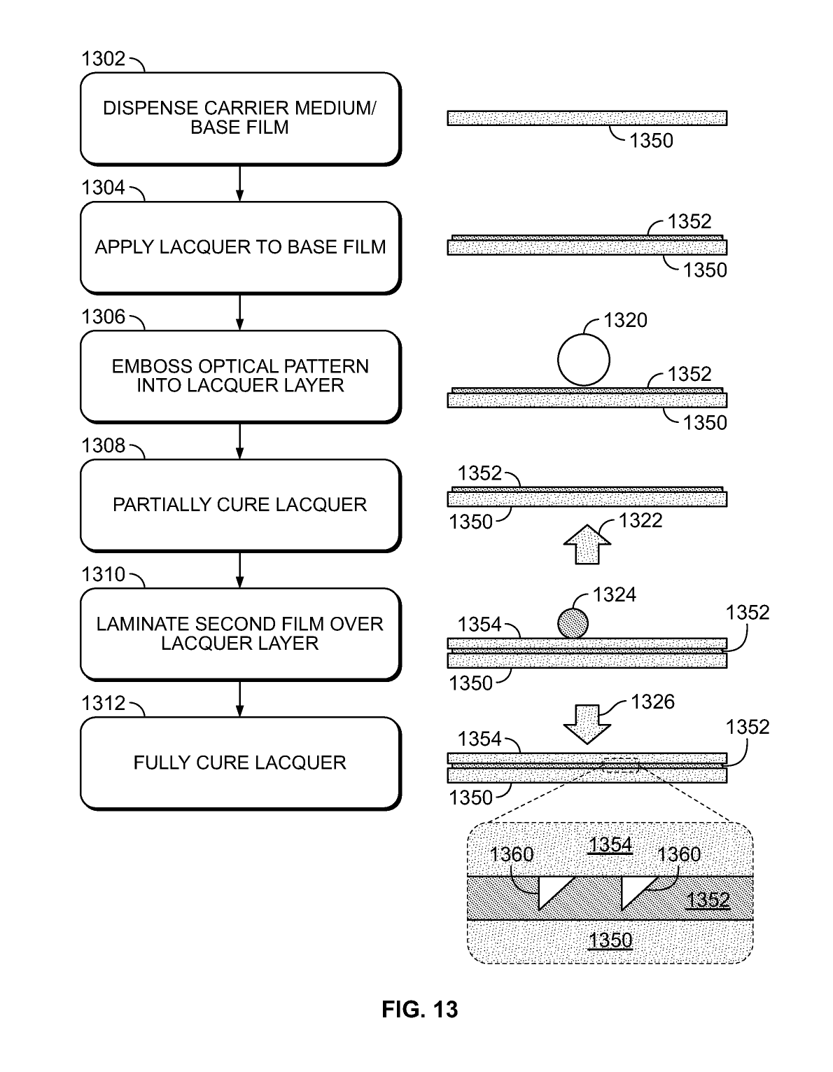

FIG. 13 illustrates an exemplary method of making a lightguide having the physical features and functionality described herein. At step 1302, a base film 1350 is dispensed. The base film 1350 may be any suitable lightguide material having the characteristics of a lower portion of the lightguide described herein. At step 1304, a lacquer layer 1352 may be applied over the base film 1350. The lacquer layer 1352 may be any lacquer or similar adhesive substance as described herein. At step 1306, a pattern of one or more of the cavity shapes described herein may be embossed (e.g., via an embossing reel 1320) into the lacquer layer 1352. That is, a surface of the embossing reel 1320 includes projections shaped to create the cavity shapes described herein. At step 1308, the lacquer layer, now embossed or imprinted with cavities having the corresponding cavity shapes, may be partially cured to fix the cavities in the lacquer.

At step 1310, a second film 1354 may be laminated (e.g., with a laminating reel 1324) over the lacquer layer 1352. The second film 1354 may be any suitable lightguide material having the characteristics of an upper portion of the lightguide described herein. Then, at step 1312, the lacquer layer 1352 is fully cured, adhering the second film 1354 to the lacquer layer 1352 over the cavities 1360, which may be filled with air or another gas or fluid that had a different refractive index than that of the film and lacquer material. The lightguide may be affixed to other components of a display device as described above (e.g., using OCAs (e.g., silicon) with a high reflectance index gap with lightguide materials such as PMMA).

As described herein, the display device may be for an electronic device which may comprise any type of electronic device having a display. For instance, the electronic device may be a mobile electronic device (e.g., an electronic book reader, a tablet computing device, a laptop computer, a smart phone or other multifunction communication device, a portable digital assistant, a wearable computing device, or an automotive display). Alternatively, the electronic device may be a non-mobile electronic device (e.g., a computer display or a television). The present disclosure provides, in one aspect, a lightguide for an electronic display that uses specular reflection of light incident on a planar reflective surface of the electronic display to display an image. Such a lightguide may include: a planar first member; a planar second member parallel to the first member and separated by a distance from the first member, the distance defining a thickness of the lightguide; a first side member orthogonal to the first and the second members and extending the distance; a second side member opposing the first side surface and extending the distance; and, an air cavity disposed between the first side member and the second side member, the air cavity receiving light propagating through the lightguide from the first side member to the second side member, and the air cavity directing the light out of the first member and toward the reflective surface. The air cavity has a cavity shape comprising: a planar first end including a first portion defined by a sector of an annulus and having a first edge at an outer radius of the annulus and a second edge at an inner radius of the annulus; a first curved surface extending from the first edge at a first angle away from the first end; and, a second curved surface extending from second edge at a second angle away from the first end, the first curved surface and the second curved surface meeting and forming an arcuate ridge at a second end of the air cavity.

The sector may be a 60-degree sector of the annulus and may define a corresponding respective length for each of the first edge, the second edge, and the ridge; the ridge thus has a radius greater than or equal to the inner radius and less than the outer radius. The first angle between the first curved surface and the first end may be at least 48 degrees and less than 54 degrees. The cavity shape may further comprise: an oblique conical third surface disposed between the base and the ridge, contiguous with the first surface, and having a first apex at the ridge and a first base defined by the second edge; and, an oblique conical fourth surface disposed between the fourth edge and the ridge, contiguous with the third surface and the first surface, and having a second apex at the ridge and a second base defined by the fourth edge.

In another aspect, the present disclosure provides a lightguide for an electronic display, the lightguide comprising: a body comprising a first light-transmissive material with a first refractive index; and, a plurality of cavities disposed within the body, a first cavity of the plurality of cavities having a first curved surface and being filled with a second light-transmissive material having a second refractive index different from the first refractive index. The second light-transmissive material may be selected to achieve a desired difference between the first refractive index and the second refractive index. The body may include a first member and a second member parallel to the first member, the first member and the second member each exhibiting total internal reflection (TIR) of incident light that impacts at an incidence angle equal to or less than a TIR threshold angle. A first cavity of the plurality of cavities may receive a portion of the incident light and direct the portion of the incident light through the first surface such that the portion of the incident light passes out of a viewing side of the electronic display. The first surface and the second surface of the lightguide may be parallel to the screen and to a planar reflective member of the electronic display, the reflective member exhibiting specular reflection, and the first cavity may direct the incident light onto the reflective member at a display angle, measured with respect to a normal of the reflective member, whereby the incident light reflects off of the reflective member and passes, at the display angle with respect to the normal of the reflective member, through one or more pixels of a pixel array of the electronic display and out of the screen.

The first cavity may include a planar first end and a second end spaced from the first end, and the first curved surface extends from the first end to the second end at a first angle with respect to the first end. The first cavity may further include a second surface extending from the first end to the second end at a second angle with respect to the first end. A first cavity of the plurality of cavities may have a planar base having a first portion shaped as a sector of an annulus, the base having a first edge at an outer radius of the annulus and a second edge at an inner radius of the annulus; the first curved surface extends from the first edge at a first angle with respect to the base, and the first cavity further comprises a second curved surface extending from the second edge at a second angle with respect to the base and meeting the first curved surface to form a ridge at a second end of the first cavity. The base may have a second portion extending from a first end of the sector defining the first portion and having an arcuate third edge, and a third portion extending from a second end of the sector and having an arcuate fourth edge; the first cavity may further include a first conical surface extending from the third edge and having a first vertex at a first end of the ridge, and a second conical surface extending from the fourth edge and having a second vertex at a second end of the ridge. The lightguide may be positioned within the electronic display such that the corresponding base of each cavity of the plurality of cavities is parallel to a planar reflective surface of the electronic display, the reflective surface exhibiting specular reflection, and such that a light source of the electronic display emits light into a side of the lightguide at a third angle offset no more than 18 degrees from the reflective surface; a portion of the light is incident on the corresponding first curved surface of a first cavity of the plurality of cavities, the first cavity directing the portion of the incident light onto the reflective surface at a fourth angle, measured with respect to a normal of the reflective surface, of no more than ten degrees.

In yet another aspect, the present disclosure provides a mobile computing device having a display panel and a lightguide coupled to the display panel, the lightguide comprising a body made of a light-transmissive material and a plurality of cavities disposed within the body, each of the plurality of cavities having a planar first end and a first curved surface extending at a first angle from the first end. The display panel may include a reflective member exhibiting spectral reflection and an array of pixels disposed between the reflective member and the lightguide; the mobile computing device may further include a light source that emits the light into the lightguide, and a portion of the light is incident on the corresponding first curved surface of a first cavity of the plurality of cavities, the first cavity directing the portion of the light toward the reflective member at a first angle, measured with respect to a normal of the reflective member, at which reflected light from the reflective member passes through the array of pixels and out of the viewing side of the electronic display.

The body may include a first surface and a second surface parallel to the first surface, the first surface and the second surface each exhibiting total internal reflection (TIR) of propagated light traveling within the body at an incidence angle, with respect to the first surface, equal to or less than a TIR threshold angle; a first cavity of the plurality of cavities may receive the propagated light and directing the propagated light through the first surface at a display angle, measured with respect to a normal of the first surface, at which display light passes out of the viewing side of the electronic display to the viewer. The corresponding first curved surface of each cavity of the plurality of cavities extends from the first end to a second end of the cavity spaced from the first end, and each cavity of the plurality of cavities further includes a second surface extending from the first end to the second end at a second angle with respect to the first end. In each cavity of the plurality of cavities: the first curved surface extends from an arcuate first edge of the first end; and the second surface is curved, extends from an arcuate second edge of the first end, and intersects the first curved surface to form an arcuate ridge at the second end. In each cavity of the plurality of cavities, the first edge of the first end is at an outer radius of an annulus and the second edge of the first end is at an inner radius of the annulus. In each cavity of the plurality of cavities: the first end includes an arcuate third edge and an arcuate fourth edge each connecting the first edge to the second edge; and, the cavity further includes a first oblique conical surface extending from the third edge and having a first vertex at a first end of the ridge, and a second oblique conical surface extending from the fourth edge and having a second vertex at a second end of the ridge.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

One skilled in the art will realize that a virtually unlimited number of variations to the above descriptions are possible, and that the examples and the accompanying figures are merely to illustrate one or more examples of implementations.

It will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular embodiments disclosed, but that such claimed subject matter may also include all embodiments falling within the scope of the appended claims, and equivalents thereof.

In the detailed description above, numerous specific details are set forth to provide a thorough understanding of claimed subject matter. However, it will be understood by those skilled in the art that claimed subject matter may be practiced without these specific details. In other instances, methods, apparatuses, or systems that would be known by one of ordinary skill have not been described in detail so as not to obscure claimed subject matter.

Reference throughout this specification to “one embodiment” or “an embodiment” may mean that a particular feature, structure, or characteristic described in connection with a particular embodiment may be included in at least one embodiment of claimed subject matter. Thus, appearances of the phrase “in one embodiment” or “an embodiment” in various places throughout this specification is not necessarily intended to refer to the same embodiment or to any one particular embodiment described. Furthermore, it is to be understood that particular features, structures, or characteristics described may be combined in various ways in one or more embodiments. In general, of course, these and other issues may vary with the particular context of usage. Therefore, the particular context of the description or the usage of these terms may provide helpful guidance regarding inferences to be drawn for that context.

What is claimed is:

1. A lightguide for an electronic display that uses specular reflection of light incident on a planar reflective surface of the electronic display to display an image, the lightguide comprising:
a planar first member;
a planar second member parallel to the first member and separated by a distance from the first member, the distance defining a thickness of the lightguide;
a first side member orthogonal to the first and the second members and extending the distance;
a second side member opposing the first side surface and extending the distance; and
an air cavity disposed between the first side member and the second side member, the air cavity receiving light propagating through the lightguide from the first side member to the second side member, and the air cavity directing the light out of the first member and toward the reflective surface, the air cavity having a cavity shape comprising:
a planar first end including a first portion defined by a sector of an annulus and having a first edge at an outer radius of the annulus and a second edge at an inner radius of the annulus;
a first curved surface extending from the first edge at a first angle away from the first end; and
a second curved surface extending from second edge at a second angle away from the first end, the first curved surface and the second curved surface meeting and forming an arcuate ridge at a second end of the air cavity.

2. The lightguide of claim 1, wherein the sector is a 60-degree sector of the annulus and defines a corresponding respective length for each of the first edge, the second edge, and the ridge, the ridge having a radius greater than or equal to the inner radius and less than the outer radius.

3. The lightguide of claim 2, wherein the first angle between the first curved surface and the first end is at least 48 degrees and less than 54 degrees.

4. The lightguide of claim 1, wherein the cavity shape further comprises:
an oblique conical third surface disposed between the base and the ridge, contiguous with the first surface, and having a first apex at the ridge and a first base defined by the second edge; and
an oblique conical fourth surface disposed between the fourth edge and the ridge, contiguous with the third surface and the first surface, and having a second apex at the ridge and a second base defined by the fourth edge.

5. A lightguide for an electronic display, the lightguide comprising:
a body comprising a first light-transmissive material with a first refractive index; and
a plurality of cavities disposed within the body, a first cavity of the plurality of cavities having a first curved surface and being filled with a second light-transmissive material having a second refractive index different from the first refractive index.

6. The lightguide of claim 5, wherein the second light-transmissive material is selected to achieve a desired difference between the first refractive index and the second refractive index.

7. The lightguide of claim 5, wherein the body comprises a first member and a second member parallel to the first member, the first member and the second member each exhibiting total internal reflection (TIR) of incident light that impacts at an incidence angle equal to or less than a TIR threshold angle;
a first cavity of the plurality of cavities receiving a portion of the incident light and directing the portion of the incident light through the first surface such that the portion of the incident light passes out of a viewing side of the electronic display.

8. The lightguide of claim 7, wherein the first surface and the second surface of the lightguide are parallel to the screen and to a planar reflective member of the electronic display, the reflective member exhibiting specular reflection, and wherein the first cavity directs the incident light onto the reflective member at a display angle, measured with respect to a normal of the reflective member, whereby the incident light reflects off of the reflective member and passes, at the display angle with respect to the normal of the reflective member, through one or more pixels of a pixel array of the electronic display and out of the screen.

9. The lightguide of claim 5, wherein the first cavity includes a planar first end and a second end spaced from the first end, and wherein the first curved surface extends from the first end to the second end at a first angle with respect to the first end.

10. The lightguide of claim 9, wherein the first cavity further includes a second surface extending from the first end to the second end at a second angle with respect to the first end.

11. The lightguide of claim 5, wherein:
a first cavity of the plurality of cavities comprises a planar base having a first portion shaped as a sector of an annulus, the base having a first edge at an outer radius of the annulus and a second edge at an inner radius of the annulus;
the first curved surface extends from the first edge at a first angle with respect to the base; and
the first cavity further comprises a second curved surface extending from the second edge at a second angle with respect to the base and meeting the first curved surface to form a ridge at a second end of the first cavity.

12. The lightguide of claim 11, wherein:
the base has a second portion extending from a first end of the sector defining the first portion and having an arcuate third edge, and a third portion extending from a second end of the sector and having an arcuate fourth edge; and
the first cavity further includes a first conical surface extending from the third edge and having a first vertex at a first end of the ridge, and a second conical surface extending from the fourth edge and having a second vertex at a second end of the ridge.

13. The lightguide of claim 11, wherein the lightguide is positioned within the electronic display such that the corresponding base of each cavity of the plurality of cavities is parallel to a planar reflective surface of the electronic display, the reflective surface exhibiting specular reflection, and such that a light source of the electronic display emits light into a side of the lightguide at a third angle offset no more than 18 degrees from the reflective surface; and
wherein a portion of the light is incident on the corresponding first curved surface of a first cavity of the plurality of cavities, the first cavity directing the portion of the incident light onto the reflective surface at a fourth angle, measured with respect to a normal of the reflective surface, of no more than ten degrees.

14. A mobile computing device having a display panel and a lightguide coupled to the display panel, the lightguide comprising:
a body made of a light-transmissive material; and
a plurality of cavities disposed within the body, each of the plurality of cavities having a planar first end and a first curved surface extending at a first angle from the first end.

15. The mobile computing device of claim 14, wherein:
the display panel includes a reflective member exhibiting spectral reflection and an array of pixels disposed between the reflective member and the lightguide;
the mobile computing device further comprises a light source that emits light into the lightguide; and
a portion of the light is incident on the corresponding first curved surface of a first cavity of the plurality of cavities, the first cavity directing the portion of the light toward the reflective member at a first angle, measured with respect to a normal of the reflective member, at which reflected light from the reflective member passes through the array of pixels and out of the viewing side of the electronic display.

16. The mobile computing device of claim 14, wherein the body comprises a first surface and a second surface parallel to the first surface, the first surface and the second surface each exhibiting total internal reflection (TIR) of propagated light traveling within the body at an incidence angle, with respect to the first surface, equal to or less than a TIR threshold angle;
a first cavity of the plurality of cavities receiving the propagated light and directing the propagated light through the first surface at a display angle, measured with respect to a normal of the first surface, at which display light passes out of the viewing side of the electronic display to the viewer.

17. The mobile computing device of claim 14, wherein the corresponding first curved surface of each cavity of the plurality of cavities extends from the first end to a second end of the cavity spaced from the first end, and wherein each cavity of the plurality of cavities further includes a second surface extending from the first end to the second end at a second angle with respect to the first end.

18. The mobile computing device of claim 17, wherein in each cavity of the plurality of cavities:
the first curved surface extends from an arcuate first edge of the first end; and
the second surface is curved, extends from an arcuate second edge of the first end, and intersects the first curved surface to form an arcuate ridge at the second end.

19. The mobile computing device of claim 18, wherein in each cavity of the plurality of cavities the first edge of the first end is at an outer radius of an annulus and the second edge of the first end is at an inner radius of the annulus.

20. The mobile computing device of claim 18, wherein in each cavity of the plurality of cavities:
the first end includes an arcuate third edge and an arcuate fourth edge each connecting the first edge to the second edge; and
the cavity further includes a first oblique conical surface extending from the third edge and having a first vertex at a first end of the ridge, and a second oblique conical surface extending from the fourth edge and having a second vertex at a second end of the ridge.
